(19) United States
(12) Patent Application Publication
(10) Pub. No.: US 2021/0024095 A1
(43) Pub. Date: Jan. 28, 2021

(54) METHOD AND DEVICE FOR CONTROLLING AUTONOMOUS DRIVING OF VEHICLE, MEDIUM, AND SYSTEM

(71) Applicant: BAIDU ONLINE NETWORK TECHNOLOGY (BEIJING) CO" LTD., Beijing (CN)

(72) Inventors: Ji TAO, Beijing (CN); Tian XIA, Beijing (CN); Xing HU, Beijing (CN)

(21) Appl. No.: 17/042,747

(22) PCT Filed: Apr. 4, 2019
(86) PCT No.: PCT/CN2019/081607

§ 371 Date: Sep. 28, 2020

(30) Foreign Application Priority Data
Sep. 19, 2018 (CN) 201811120306.5

(51) Int. Cl. B60W 60/00

(52) U.S. Cl. CPC B60W 60/0027; B60W 2554/4041; B60W 2554/4046; B60W 60/0011

(57) ABSTRACT

Embodiments of the present disclosure provide a method and a device for controlling autonomous driving of a vehicle, a medium and a system. The method for controlling autonomous driving of a vehicle includes: acquiring an environment sensing result related to an environment around the vehicle, the environment sensing result being based on sensing information collected by at least one sensor arranged in the environment and independent of the vehicle, and the environment sensing result being configured to indicate relevant information of a plurality of objects in the environment; determining an external sensing result of the vehicle by excluding a self-vehicle sensing result corresponding to the vehicle from the environment sensing result; and controlling a driving behavior of the vehicle based at least on the external sensing result.

### CROSS-REFERENCE TO RELATED APPLICATIONS

This application is a US national application of International Application No. PCT/CN 2019/081607, filed on Apr. 4, 2019, which is based on and claims priority to Chinese Patent Application No. 201811120306.5, filed on Sep. 19, 2018, the entire contents of which are incorporated herein by reference.

### TECHNICAL FIELD

Embodiments of the present disclosure mainly relate to the field of vehicle outside interaction, and more particularly, to a method and an apparatus for controlling autonomous driving of a vehicle, a device, a computer-readable storage medium, and a cooperative vehicle infrastructure system.

### BACKGROUND

In recent years, technologies related to autonomous driving (also known as driverless driving) have gradually emerged. Autonomous driving capabilities of vehicles are increasingly desirable.

### SUMMARY

Embodiments of the present disclosure provide a solution for controlling autonomous driving of a vehicle.

Embodiments of the present disclosure provides a method for controlling autonomous driving of a vehicle. The method includes: acquiring an environment sensing result related to an environment around the vehicle, in which the environment sensing result is based on sensing information collected by at least one sensor arranged in the environment and independent of the vehicle, and the environment sensing result is configured to indicate relevant information of a plurality of objects in the environment; determining an external sensing result of the vehicle by excluding a self-vehicle sensing result corresponding to the vehicle from the environment sensing result; and controlling a driving behavior of the vehicle based at least on the external sensing result.

Embodiments of the present disclosure provides a device including one or more processors, and a storage device. The storage device is configured to store one or more programs. When the one or more programs are implemented by the one or more processors, the one or more processors are configured to implement the method of embodiments of the present disclosure.

Embodiments of the present disclosure provides a cooperative vehicle infrastructure system. The system includes a vehicle-side control apparatus, at least one sensor, and a roadside assistance apparatus. The vehicle-side control apparatus includes the apparatus of the second aspect. The at least one sensor is disposed in an environment and independent of a vehicle, and configured to collect sensing information related to the environment. The roadside assistance apparatus is configured to process the sensing information to determine an environment sensing result related to the environment.

It should be understood that, the content described in the summary is not intended to limit key or important features of embodiments of the present disclosure, nor is it intended to limit the scope of the present disclosure. Other features of the present disclosure will become readily understood from the following description.

### BRIEF DESCRIPTION OF THE DRAWINGS

The above and other features, advantages, and aspects of embodiments of the present disclosure will become more apparent with reference to the accompanying drawings and the following detailed description. In the drawings, the same or similar reference numerals indicate the same or similar elements, in which:

FIG. 1 is a schematic diagram illustrating an example environment in which various embodiments of the present disclosure may be implemented.

FIG. 2 is a block diagram illustrating a cooperative vehicle infrastructure system according to some embodiments of the present disclosure.

FIG. 3 is a schematic diagram illustrating an example static map according to some embodiments of the present disclosure.

FIG. 4 is a flowchart of a process for controlling autonomous driving of a vehicle according to some embodiments of the present disclosure.

FIG. 5 is a flowchart of a process for assisting in controlling autonomous driving of a vehicle according to some embodiments of the present disclosure.

FIG. 6 is a block diagram illustrating a computing device capable of implementing various embodiments of the present disclosure.

### DETAILED DESCRIPTION

Embodiments of the present disclosure will be described in more detail below with reference to the accompanying drawings. While certain embodiments of the present disclosure have been illustrated in the accompanying drawings, it is to be understood that the present disclosure may be embodied in various forms and should not be construed as being limited to the embodiments set forth herein. Instead, these embodiments are provided for a thorough and complete understanding of the present disclosure. It should be understood that the drawings and embodiments of the present disclosure are for illustrative purposes only and are not intended to limit the scope of the present disclosure.

In the description of the embodiments of the present disclosure, the term “including” and its equivalents should be construed as open-ended inclusions, i.e., “include, but is not limited to”. The term “according to” is to be understood as “at least partially according to”. The term “an embodiment” or “the embodiment” should be understood as “at least one embodiment”. Terms “first”, “second” and the like may refer to different or identical objects. Other explicit and implicit definitions may also be included below.

The basis of autonomous driving technology is the sensing of the surrounding environment of the vehicle, i.e., recognizing specific conditions of the surrounding environment. Only on the basis of sensing the environment, the driving behavior that the vehicle can perform in the current environment can be determined, and the vehicle can be further controlled to realize the corresponding driving behavior. Currently, in the field of autonomous driving, the vehicle itself is required to be able to sense the surrounding environment, the vehicle thus needs to be provided with various sensing devices, such as a lidar. However, such sensing devices have high manufacturing and maintenance costs, and cannot be reused as the vehicle is updated. In addition, high requirements for the vehicle's sensing ability make it impossible to easily and inexpensively upgrade non-autonomous vehicles or vehicles with weak autonomous driving capabilities to vehicles with high autonomous driving capabilities.

As mentioned above, in order to support the autonomous driving capability of the vehicle, it is important to sense the surrounding environment of the vehicle. In traditional autonomous driving technology, vehicles are required to be equipped with high-cost sensors to obtain the sensing capability, which not only increases costs economically, and also hinders the improvement of the autonomous driving capability of existing vehicles.

Generally, the accuracy of the sensor is often proportional to the cost of the. If the cost of the sensor is reduced in order to save the cost, it will inevitably reduce the sensing performance, or it may need more low-performance sensors cooperate with each other to reduce the sensing blind areas as much as possible. In the process of use, once the on-board sensor is damaged, the maintenance of the individual vehicles or devices will bring additional costs. In addition, the sensors installed on each vehicle are usually adapted to the design and manufacture of the vehicle itself, and they may not be reused as the vehicle is scrapped. On the other hand, the high requirements on the vehicle's sensing ability make it impossible to upgrade non-autonomous vehicles or vehicles with weak autonomous driving capabilities to vehicles with strong autonomous driving capabilities easily and at low cost. Generally, upgrading the autonomous driving capability of the vehicle may only be achieved by replacing the vehicle.

According to embodiments of the present disclosure, an autonomous driving control solution with external assist sensing is provided. In the solution, sensing information related to the environment is collected by sensors arranged in the environment around the vehicle and independent of the vehicle, and the environment sensing result is determined based on the sensing information. The self-vehicle sensing result corresponding to the vehicle is excluded from the environment sensing result, so as to obtain the external sensing result of the vehicle for controlling the driving behavior of the vehicle. By performing the sensing of the environment through the sensors outside the vehicle, requirements on the vehicle's own sensing capability can be reduced, enabling the non-autonomous vehicles or vehicles with weak autonomous driving capabilities to simply and cost-effectively improve the autonomous driving capabilities. The sensors outside the vehicle may also be configured to assist the autonomous driving control of multiple vehicles in the environment, thereby improving the utilization of the sensors.

Hereinafter, embodiments of the present disclosure will be described in detail with reference to the accompanying drawings.

Example Environment and System

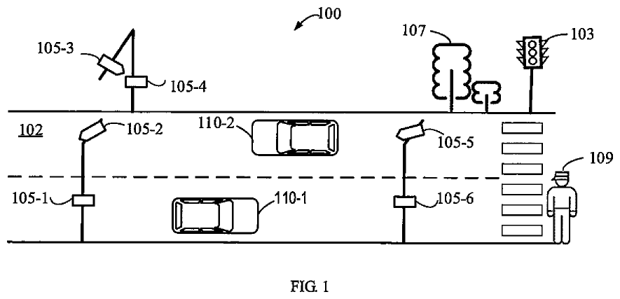

FIG. 1 is a schematic diagram of an example environment 100 in which various embodiments of the present disclosure may be implemented. Some typical objects are shown schematically in the example environment 100, including a road 102, a traffic indication facility 103, plants 107 on both sides of the road, and a pedestrian 109 that may appear. It should be understood that, these illustrated facilities and objects are merely examples, and objects that may appear in different traffic environments will vary according to actual conditions. The scope of the present disclosure is not limited in this regard.

In the example of FIG. 1, one or more vehicles 110-1, 110-2 are driving on the road 102. For ease of description, the multiple vehicles 110-1 and 110-2 are collectively referred to as the vehicle 110. The vehicle 110 may be any type of vehicle that can carry people and/or objects and move through a power system such as an engine, including but not limited to a car, a truck, a bus, an electric vehicle, a motorcycle, a recreational vehicle, a train, and the like. The one or more vehicles 110 in the environment 100 may be vehicles with a certain degree of autonomous driving capability, such vehicles are also referred to as driverless vehicles. Certainly, the other or some vehicles 110 in the environment 100 may also be vehicles that do not have autonomous driving capability.

One or more sensors 105-1 to 105-6 (collectively referred to as sensor 105) are also arranged in the environment 100. The sensor 105 is independent of the vehicle 110 and is configured to monitor the condition of the environment 100 to obtain sensing information related to the environment 100. To monitor the environment 100 in all directions, the sensor 105 may be arranged near the road 102 and may include one or more types of sensors. For example, the sensor 105 may be arranged on both sides of the road 102 at a certain interval, so as to monitor a specific area of the environment 100. Various types of sensors may be arranged in each area. In some examples, in addition to fixing the sensor 105 at a specific location, a mobile sensor 105, such as a mobile sensing site or the like, may also be provided.

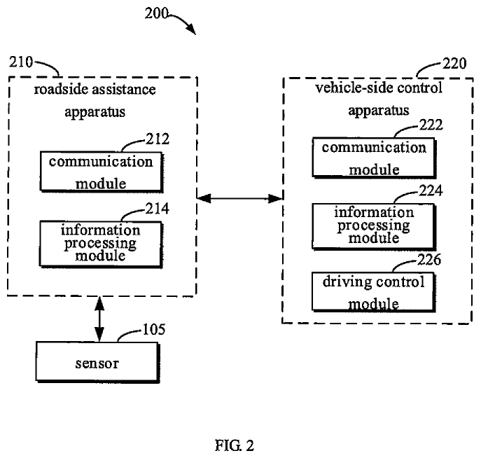

The sensing information collected by the sensor 105 arranged correspondingly to the road 102 may also be referred to as roadside sensing information. The roadside sensing information may be configured to facilitate driving control of the vehicle 110. In order to realize the autonomous driving control of the vehicle 110 by using the roadside sensing information, the roadside and the vehicle side may perform the control of the vehicle in cooperation. FIG. 2 is a block diagram illustrating a cooperative vehicle infrastructure system 200. For ease of description, the cooperative vehicle infrastructure system 200 will be discussed below with reference to FIG. 1.

The cooperative vehicle infrastructure system 200 includes a sensor 105, a roadside assistance apparatus 210 for assisting autonomous driving of the vehicles 110, and a vehicle-side control apparatus 220 for controlling autonomous driving of the vehicle 110. The roadside assistance apparatus 210 may also sometimes be referred to herein as a device for assisting autonomous driving of the vehicle. The roadside assistance apparatus 210 is configured to assist in controlling the autonomous driving of the vehicle appearing in the environment 100 in combination with the environment 100. The roadside assistance apparatus 210 may be installed at any position, as long as the roadside assistance apparatus 210 can communicate with the sensor 105 and the vehicle-side control apparatus 220. Since both the sensor 105 and the roadside assistance apparatus 210 are deployed on the roadside, the sensor 105 and the roadside assistance apparatus 210 may also form a roadside assistance subsystem.

The vehicle-side control apparatus 220 is also sometimes referred to herein as a device that controls the autonomous driving of the vehicle 110. The vehicle-side control apparatus 220 is used in association with a corresponding vehicle 110. For example, the vehicle-side control apparatus 220 is integrated into the vehicle 110 to control the autonomous driving of the vehicle 110. One or more vehicles 110 in the environment 100 may be respectively provided with the vehicle-side control apparatus 220. For example, a vehicle-side control apparatus 220 may be integrated on the vehicle 110-1, and similarly, a vehicle-side control apparatus 220 may also be integrated on the vehicle 110-2. In the following, the corresponding functions of the vehicle-side control apparatus 220 are described for one vehicle 110.

The roadside assistance apparatus 210 includes a communication module 212 and an information processing module 214. The communication module 212 may support wired/wireless communication with the sensor 105, and is configured to acquire the sensing information related to the environment 100 from the sensor 105. The communication module 212 may also support communication with the vehicle-side control apparatus 220, and the communication is usually wireless communication. The communication of the communication module 212 with the sensor 105 and the vehicle-side control apparatus 220 may be based on any communication protocol, and the implementation of the present disclosure is not limited in this regard.

As mentioned above, in order to monitor the environment 100 in all directions, the sensors 105 arranged in the environment 100 may include various types of sensors. Examples of the sensors 105 may include, but are not limited to: an image sensor (such as a camera), a lidar, a millimeter wave radar, an infrared sensor, a positioning sensor, a light sensor, a pressure sensor, a temperature sensor, a humidity sensor, a wind speed sensor, a wind direction sensor, an air quality sensor, and the like. The image sensor may be configured to collect image information related to the environment 100. The lidar and millimeter wave radar may be configured to collect laser point cloud data related to the environment 100. The infrared sensor may be configured to detect environmental conditions in the environment 100 by using infrared light. The positioning sensor may be configured to collect position information of an object related to the environment 100. The light sensor may be configured to collect a metric value that indicates the light intensity in the environment 100. The pressure sensor, the temperature sensor, and the humidity sensor may be configured to collect metric values that indicate the pressure, the temperature, and the humidity in the environment 100, respectively. The wind speed sensor and the wind direction sensor may be configured to collect metric values that indicate the wind speed and the wind direction in the environment 100, respectively. The air quality sensor may be configured to collect indicators related to air quality in the environment 100, such as the oxygen concentration, carbon dioxide concentration, dust concentration, contaminant concentration in the air. It should be understood that, only a few examples of the sensors 105 are listed above. According to actual needs, there may be other types of sensors. In some embodiments, different sensors may be integrated at a certain location or may be distributed in an area of the environment 100 to monitor a specific type of roadside sensing information.

Since the amount of data of the sensing information directly collected by the sensor 105 is large and diversified, when the sensing information collected by the sensor 105 is directly transmitted to the vehicle-side control apparatus 220, it may not only result in a large communication transmission overhead and excessive occupation of communication resources, and also the same sensing information may need to be separately processed in different vehicles, resulting in the overall performance degradation of the system. In the implementation of the present disclosure, the sensing information collected by the sensor 105 is collectively processed by the roadside assistance apparatus 210 (specifically, by the information processing module 214 in the roadside assistance apparatus 210).

The information processing module 214 in the roadside assistance apparatus 210 may be configured to process the sensing information acquired from the sensor 105, so as to determine the environment sensing result related to the environment 100. The environment sensing result may be understood as indicating the overall condition of the environment 100, and may specifically indicate relevant information of multiple objects including the vehicle 110 in the environment. The relevant information may include the size, position (for example, a fine position in the Earth coordinate system), speed, motion direction, distance from a specific viewpoint, and the like of each object. The information processing module 214 may fuse different types of sensing information from different sensors 105 to determine the environment sensing result. The information processing module 214 may use various information fusion technologies to determine the environment sensing result.

In order to ensure the safe driving of the vehicle 110, the accuracy of the relevant information of each object provided by the environment sensing result should be high. The specific processing of the roadside assistance apparatus 210 to the sensing information collected by the sensor 105 will be described in detail below. The communication module 212 in the roadside assistance apparatus 210 is configured to transmit the environment sensing result processed by the information processing module 214 to the vehicle-side control apparatus 220.

The vehicle-side control apparatus 220 may control the corresponding vehicle 110 (for example, the driving behavior in which the vehicle-side control apparatus 220 is installed) based on the environment sensing result acquired from the roadside assistance apparatus 210. The vehicle-side control apparatus 220 includes a communication module 222, an information processing module 224, and a driving control module 226. The communication module 222 is configured to be communicatively coupled with the roadside assistance apparatus 210, and particularly the communication module 212 in the roadside assistance apparatus 210, to receive the environment sensing result from the communication module 212. The information processing module 224 is configured to perform processing on the environment sensing result to make the environment sensing result suitable for the autonomous driving control of the vehicle 110. The driving control module 226 is configured to control the driving behavior of the vehicle 110 based on the processing result of the information processing module 224.

Vehicle-Side Driving Control

The process of the vehicle-side control apparatus 220 performing autonomous driving control of the vehicle 110 will be described in detail below first.

The communication module 222 in the vehicle-side control apparatus 220 may obtain the environment sensing result related to the environment 100 around the vehicle 110 from the roadside assistance apparatus 210. The environment sensing result is based on the sensing information collected by one or more sensors 105 arranged in the environment and independent of the vehicle 110, and configured to indicate relevant information of multiple objects in the environment, such as the size, position (e.g., the fine position in the earth coordinate system), speed, motion direction, and distance from a specific viewpoint of the object.

In some embodiments, in addition to obtaining the environment sensing result from the roadside assistance apparatus 210, the vehicle-side control apparatus 220 may also obtain the environment sensing result from sensors integrated in other vehicles in the environment 100 as supplements. Some vehicles in the environment 100 may have sensors with strong sensing capabilities (such as lidars) or sensors with general sensing capabilities (such as cameras). The sensing information collected by these sensors may also assist the autonomous driving control of other vehicles. For a certain vehicle (for example, the vehicle 110-1), the vehicle-side control apparatus 220 associated with the vehicle 110-1 may obtain, from sensors on other vehicles (for example, the vehicle 110-2), original sensing information or the sensing result obtained by processing the original sensing information.

Generally, the sensor installed on the vehicle may detect the surrounding environment from the perspective of the vehicle itself, the sensing information obtained does not include information related to the vehicle itself. However, since sensors outside the vehicle (such as roadside sensors or sensors on other vehicles) observe the entire environment from the sensors themselves, instead of the perspective of the vehicle, these sensors monitor relevant information about the vehicle and other objects without difference, and thus the information acquired includes sensing information about objects in the entire environment.

According to some embodiments of the present disclosure, the information processing device 224 may exclude the self-vehicle sensing result corresponding to the vehicle 110 from the environment sensing result to determine the external sensing result of the vehicle 110. The self-vehicle sensing result may refer to information related to the vehicle 110 itself in the environment sensing result, such as the size, position, speed, direction, and distance from a specific viewpoint of the vehicle 110. The external sensing result includes relevant information of objects other than the vehicle 110. During the driving of the vehicle 110, the vehicle 110 needs to treat all objects other than vehicle 110 itself as obstacles, so as to reasonably plan the driving path and avoid collision with the obstacles. In embodiments of the present disclosure, by recognizing and excluding the self-vehicle sensing result from the environment sensing result, the external sensing result may be more suitable for the autonomous driving control of the vehicle 110.

In order to determine the external sensing result of the vehicle 110 from the comprehensive environment sensing result, in some embodiments, the vehicle 110 may be provided with a label section for recognizing the vehicle 110. The label section may be one or more of the following: a license plate of the vehicle 110, a two-dimensional code affixed to the outside of the vehicle 110, a non-visible light label affixed to the outside of the vehicle 110, and a radio frequency label mounted on the vehicle 110.

Motor vehicles driving on the road are usually provided with license plates for uniquely identifying the vehicles. In some cases, for a vehicle without a license plate or considering that the license plate is likely to be obscured, a two-dimensional code specific to the vehicle 110 may be affixed outside the vehicle 110 as the label section of the vehicle. The license plate and/or two-dimensional code of the vehicle 110 may be recognized from image information collected by the image sensor. In some examples, in order not to affect the appearance of the vehicle, the non-visible light label, such as an infrared or ultraviolet reflective label, may be affixed to the vehicle 110 to identify the vehicle 110. The non-visible light label may be identified by a non-visible light sensor. Alternatively or additionally, the radio frequency label mounted on the vehicle 110 may also be configured to identify the vehicle 110. The radio frequency label may transmit a signal, and read the transmitted signal through a radio frequency reader to identify the vehicle 110.

Through the label section of the vehicle 110, the information processing module 224 may identify identification information related to the label section of the vehicle 110 from the environment sensing result. The identification information may be, for example, the license plate or two-dimensional code image information of the vehicle 110, indication information indicating specific signals of the non-visible light label and the radio frequency label, and the like. The information processing module 224 may identify the corresponding identification information by matching the identification indicated by the label section of the vehicle with the environment sensing result. Then, the information processing module 224 determines the self-vehicle sensing result corresponding to the vehicle 110 from the environment sensing result based on the identification information. Generally, the roadside assistance apparatus 210 combines relevant information of each object. Therefore, through the identification information of the vehicle 110, other information related to the vehicle 110, such as the position, size, and the like of the vehicle 110, in the environment sensing result may be determined.

In some embodiments, in addition to identifying the vehicle 110 by using the label section provided on the vehicle, the self-vehicle sensing result in the environment sensing result may also be recognized based on the position of the vehicle 110. As mentioned above, the environment sensing result may include the positions of multiple objects. The information processing module 224 may determine the position of the vehicle 110 by using various positioning technologies, and then match the position of the vehicle 110 with the positions of multiple objects in the environment sensing result to identify an object that matches the vehicle 110 from the multiple objects. In this manner, the information processing module 224 may recognize which object in the environment sensing result is the vehicle 110. Therefore, the information processing module 224 may exclude the sensing result corresponding to the object that matches the vehicle 110 from the environment sensing result, and obtain the external sensing result.

When the external sensing result is determined based on position matching, the position of the vehicle 110 may be a fine position of the vehicle 110 (for example, similar to the accuracy of positions of the objects included in the environment sensing result) or may be a rough position of the vehicle 110 (for example, sub-meter positioning). When the objects in the environment 100 are relatively far away from each other, the rough position of the vehicle 110 may also be used to accurately match the matching object at the overlapping position from the environment sensing result. In some embodiments, the position of the vehicle 110 may be determined by a positioning device, such as a global positioning system (GPS) antenna, a position sensor, and the like, that the vehicle 110 has. The vehicle 110 may also perform positioning based on other positioning technologies, such as a base station in communication with the communication module 222 and/or a roadside assistance apparatus 210 arranged in the environment 100, or any other technology.

After the self-vehicle sensing result of the vehicle 110 is recognized, the information processing module 224 may delete or ignore the self-vehicle sensing result corresponding to the vehicle 110 in the environment sensing result, and only consider other environment sensing result (i.e., the external sensing result). The external sensing result is used by the driving control module 226 in the vehicle-side control apparatus 220 to control the driving behavior of the vehicle 110. The driving control module 226 may use various autonomous driving strategies to control the driving behavior of the vehicle 110 on the basis of the known external sensing result. The driving behavior of the vehicle 110 may include a driving path, a driving direction, a driving speed, and the like of the vehicle 110. The driving control module 226 may generate a specific operation instruction for the driving behavior of the vehicle 110, such as the operation instruction for the driving system and steering system of the vehicle, such that the vehicle 110 drives according to the operation instruction. The operation instruction may be, for example, any instruction related to the driving of the vehicle 110, such as acceleration, deceleration, left steering, right steering, parking, whistling, turning on or off the lights, and the like.

In some embodiments, in controlling the driving behavior of the vehicle 110, the driving control module 226 may determine a behavior prediction of one or more objects (that is, obstacles) in the environment 100 based on the external sensing result. The behavior prediction includes one or more aspects of an expected motion trajectory, an expected motion speed, and an expected motion direction of the object. The behavior prediction of the object is also useful for the autonomous driving control of the vehicle, for the autonomous driving control of the vehicle often needs to determine the further motion of the objects around the vehicle, so as to take corresponding driving behaviors to respond. In some embodiments, the driving control module 226 may perform behavior prediction based on a pre-trained prediction model. The prediction model may be, for example, a general behavior prediction mode, or may include different prediction models for different types of objects. The driving control module 226 may determine the driving behavior of the vehicle 110 based on the behavior prediction of the object.

In some embodiments, when controlling the driving behavior of the vehicle, the information processing module 224 may control the driving of the vehicle based on the position of the vehicle 110, in addition to the external sensing result. Generally, for accurate and safe autonomous driving control, it is desirable to know the fine position of the vehicle 110. In an embodiment, the vehicle 110 may be provided with a sensor capable of performing fine positioning. In another embodiment, the fine position of the vehicle 110 may also be determined from the environment sensing result, which may reduce the requirement for the fine positioning hardware of the vehicle 110, and improve the positioning accuracy and stability.

As discussed above, the environment sensing result includes a high accuracy position of the vehicle 110. The fine position used in the autonomous driving control of the vehicle 110 may be determined from the environment sensing result. In the embodiment, the vehicle-side control apparatus 220 may include a vehicle positioning module (not shown). The vehicle positioning module may be configured to identify the vehicle 110 from the environment sensing result by means of position matching.

In detail, the vehicle positioning module may first determine the rough position of the vehicle 110, for example, by using the GPS antenna of the vehicle 110 or by using an auxiliary device such as a base station. The vehicle positioning module determines the object matching the vehicle 110 from the environment sensing result based on the rough position of the vehicle 110, and determines the position of the object matching the vehicle 110 in the environment sensing result as the fine position (that is, a position with a high accuracy) of the vehicle 110. In this manner, the fine position of the vehicle 110 may be obtained for controlling the driving behavior of the vehicle 110 without requiring the vehicle 110 or the vehicle-side control apparatus 220 to have a fine on-board positioning device.

In other embodiments, as discussed above, the self-vehicle sensing result corresponding to the vehicle 110 may also be identified by the label section provided with the vehicle 110. Therefore, the fine positioning of the vehicle 110 may be obtained from the identified self-vehicle sensing result, which may enable the vehicle 110 to achieve fine positioning even without the on-board positioning device.

In some embodiments of the present disclosure, the vehicle-side control apparatus 220 may obtain other driving assistance information for assisting the autonomous driving of the vehicle 110 in addition to obtaining the environment sensing result from the roadside assistance apparatus 210. In an embodiment, the communication module 222 in the vehicle-side control apparatus 220 may obtain behavior predictions of one or more objects in the environment 100 from the roadside assistance apparatus 210 (e.g., from the communication module 212). The behavior prediction includes one or more aspects of the expected motion trajectory, the expected motion speed, and the expected motion direction of the object. In another embodiment, the communication module 222 in the vehicle-side control apparatus 220 may obtain an autonomous driving recommendation for the vehicle 110 from the roadside assistance apparatus 210 (for example, from the communication module 212). The autonomous driving recommendation includes one or more of a driving path recommendation, and a driving direction recommendation of the vehicle 110, and a specific operation instruction recommendation for controlling the driving behavior of the vehicle.

In addition to the external sensing result, the driving control module 226 of the vehicle-side control apparatus 220 may also control, based on the behavior prediction about the object and/or the autonomous driving recommendation obtained from the roadside assistance apparatus 210, the driving behavior of the vehicle 110. In controlling the driving behavior of the vehicle 110, the vehicle-side control module 226 may refer to or adjust the behavior prediction and/or the autonomous driving recommendation obtained from the roadside assistance apparatus 210 to determine the actual driving behavior of the vehicle 110.

By performing the behavior prediction and autonomous driving recommendation through the roadside assistance apparatus 210, requirements for the autonomous driving capability of the vehicle 110 or the vehicle-side control apparatus 220 can be further reduced, and the processing and control complexity of the vehicle side can be reduced. For example, the vehicle-side control apparatus 220 may, based on a simple autonomous driving control strategy, and the behavior prediction and/or autonomous driving recommendation obtained from the roadside assistance apparatus 210, and in combination with the actual external sensing result, determine the driving behavior of the vehicle 110.

It has been described above that the vehicle-side control apparatus 220 obtains the environment sensing result from the road-side assistance device 210 and may also obtain the behavior prediction of the object and/or autonomous driving recommendation to control the driving behavior of the vehicle 110. In the above embodiments, the sensor 105 and the roadside assistance apparatus 210 assume the function of sensing the surrounding environment of the vehicle 110. In addition, the sensor 105 and the roadside assistance apparatus 210 may also provide driving assistance information such as the behavior prediction and/or autonomous driving recommendation. The environment sensing result and other driving assistance information obtained by the roadside assistance apparatus 210 and the sensor 105 may be provided to multiple vehicles 110 in the environment 100, thereby achieving centralized environment sensing and information processing.

Under the implementation, the vehicle 110 can realize the autonomous driving without requiring it to have strong environment sensing capability, self-positioning capability, behavior prediction capability, and/or autonomous driving planning capability. The improvement of the autonomous driving capability of the vehicle 110 may be achieved by integrating the vehicle-side control apparatus 220. For example, the function of the vehicle-side control apparatus 220 may be integrated into the vehicle 110 by upgrading the software system of the vehicle 110 and by the additional communication function, or by virtue of the communication function that the vehicle 110 has. In addition, the provision of the behavior prediction capability and/or autonomous driving recommendation by the roadside assistance apparatus 210 may guarantee the continuous autonomous driving process of the vehicle 110 in the event that the hardware and/or software of the vehicle 110 fails and the behavior prediction and driving planning cannot be performed.

In a specific example, when the roadside assistance apparatus 210 and the sensor 105 are deployed in a certain road section of the vehicle driving road system, only by integrating the vehicle-side control apparatus 220, the vehicle 110 traveling to the road section may obtain more powerful autonomous driving capability. In some cases, the vehicle 110 that do not have autonomous driving capability (such as vehicles classified to level 0 L0 and level 1 L1 in the autonomous driving classification) or the vehicle 110 that have a weak driving capability (such as vehicles of level 2 L2) may obtain more powerful autonomous driving capability (for example, similar to that of autonomous vehicles in level 3 L3 or level 4 L4) by using the environment sensing result.

Roadside Driving Assistance Control

The above embodiments mainly describe the specific implementation of the vehicle-side control apparatus 220 in the cooperative control system 200 illustrated in FIG. 2. Hereinafter, some embodiments of the roadside assistance apparatus 210 in the cooperative control system 200 will be further described.

According to some embodiments of the present disclosure, the roadside assistance apparatus 210 acquires the sensing information of the sensor 105, and determines the environment sensing result by processing the sensing information. Then, the roadside assistance apparatus 210 provides the environment sensing result to the vehicle-side control apparatus 220 for assisting in controlling the driving behavior of the vehicle 110.

In some embodiments, in order to further reduce the processing complexity of the vehicle-side control apparatus 220, the road-side assistance device 210 may determine the external sensing result(s) corresponding to one or more vehicles 110 from the environment sensing result, and provide the external sensing result(s) to the vehicle-side control apparatus 220. That is, the sensing results that the roadside assistance apparatus 210 provides to each vehicle 110 are different external sensing results for each vehicle and can be directly used for driving control of these vehicles. In detail, the information processing module 214 in the roadside assistance apparatus 210 excludes the self-vehicle sensing result corresponding to a vehicle 110 from the environment sensing result, thereby determining the external sensing result of the vehicle 110. The roadside assistance apparatus 210 then provides the determined external sensing result to the vehicle-side control apparatus associated with the vehicle for assisting in controlling the driving behavior of the vehicle.

The manner in which the information processing module 214 identifies the external sensing result of a certain vehicle 110 is similar to the manner adopted by the vehicle-side control apparatus 220. For example, the information processing module 214 may also identify the vehicle 110 based on a label section provided with the vehicle 110, the label section may be one or more of, such as the license plate, the two-dimensional code, the non-visible light label, and the radio frequency label of the vehicle 110. In detail, the information processing module 214 identifies identification information related to the label section provided with the vehicle 110 from the environment sensing result, and then determines the self-vehicle sensing result corresponding to the vehicle 110 in the environment sensing result based on the identification information. The information processing module 214 may exclude the self-vehicle sensing result from the environment sensing result to obtain the external sensing result, so as to provide the external sensing result to the vehicle-side control apparatus 220.

In some embodiments, in order to quickly and accurately determine the environment sensing result from the sensing information obtained by the sensor 105, the information processing module 214 may also determine the environment sensing result by means of a static high definition map associated with the environment 100. The static high definition map includes information about static objects in the environment 100. The static high definition map may be generated based on the information related to the environment 100 that is previously collected by the sensor 105 arranged in the environment 100. The static high definition map includes only information about objects in the environment 100 that protrude above the ground and remain static for a relatively long time.

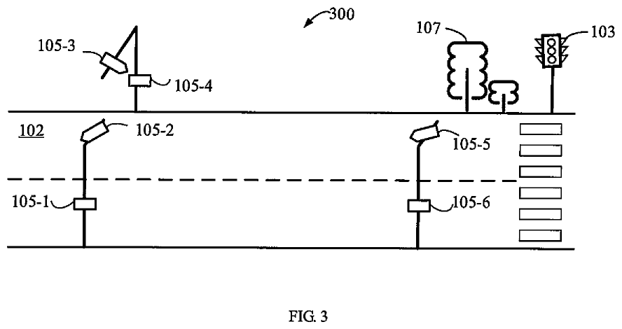

FIG. 3 illustrates an example of a static high definition map 300 associated with the environment 100 of FIG. 1. Compared with the environment 100, the static high definition map 300 includes only static objects, such as poles with the sensor 105, the traffic indication facilities 103, plants 107 on both sides of the road, etc. These objects remain stationary for a period of time. Objects such as the vehicle 110 and pedestrian 109 sometimes appear in the environment 100, sometimes disappear from the environment 100, or move in the environment 100 are called dynamic objects.

It should be understood that, the static high definition map 300 illustrated in FIG. 3 is only provided for the purpose of illustration. Generally, in addition to schematically illustrating objects or giving images of the objects, the high definition map may also mark other information about the object, such as the fine position, speed, direction, and the like. In some implementations, the static high definition map includes a three-dimensional (3D) static high definition map, which includes relevant information of the object in the 3D space.

At the initial stage, the static high definition map, such as the static high definition map 300, may be generated based on the relevant information associated with the environment 100 collected by a high definition map acquisition vehicle. The static high definition map associated with the environment 100 may be updated periodically or be updated by triggering a corresponding event. The update period of the static high definition map may be set to a relatively long period of time. The update of the static high definition map may be based on the sensing information collected by the sensor 105 that is arranged in the environment 100 and monitors the environment 100 in real time.

When the static high definition map is used to determine the environment sensing result, for the purpose of autonomous driving, the environment sensing result needs to reflect the real-time condition of the environment 100. Therefore, the information processing module 214 may update the static high definition map by using the real-time sensing result provided by the sensor 105, and obtain the real-time high definition map associated with the environment 100 as the environment sensing result. When the static high definition map is updated, the sensing information from the sensor 105 may be fused with the static high definition map, such that the dynamic objects and relevant information of the dynamic objects in the sensing information can be combined into the static high definition map.

When determining the environment sensing result, the use of the static high definition map may correct or delete objects that may be incorrectly detected in the real-time sensing information, thereby improving the accuracy of the environment sensing result. For example, due to the error of the real-time sensing information, an object in the environment 100 is detected to have a certain speed, and by combining the static high definition map, it can be determined that the object is actually a static object, thus it can avoid incorrectly marking the speed of the object, and affect the autonomous driving control of the vehicle 110.

In some embodiments, the static high definition map may be configured to mark the fine position of the object in the environment 100, and the fine position may form part of the environment sensing result. In detail, the information processing module 214 may use image sensing information in the sensing result collected by the sensor 105, and recognize objects in the environment from the image sensing information, the recognized objects include static objects and other objects (such as dynamic objects newly entering the environment 100) in the environment. The recognition of the objects may be achieved by the image processing technology for object recognition.

The information processing module 214 may, based on the relative position relationship between the recognized static objects and other objects, determine the positions of other objects from positions of the static objects indicated by the static high definition map. The image sensing information collected by the image sensor may generally not indicate the geographic location such as the detail position in the earth coordinate system of the object therein, but the image sensing information can reflect the relative position relationship of different objects. Based on the relative position relationship, the fine positions of other objects may be determined from the positions of the static objects indicated by the known static high definition map. When determining the fine positions of other objects, the absolute geographical positions of other objects in the environment 100 may also be determined by referring to the conversion relationship of the static object from the image sensing information to the static high definition map. The high-precision positions may be quickly and accurately obtained by using the object positioning of the static high definition map, which can reduce computational cost required for fine positioning.

As mentioned in the above description on the vehicle-side control apparatus 220, in addition to providing the environment sensing result or the external sensing result, the roadside assistance apparatus 210 may also process the environment sensing result to obtain other driving assistance information for the one or more vehicles in the environment 100, such as the behavior prediction of the object in the environment 100 and/or the autonomous driving recommendation for a particular vehicle 110. The determination of the behavior prediction of the object and the autonomous driving recommendation of the vehicle in the roadside assistance apparatus 210 will be discussed in detail below.

In some embodiments, the roadside assistance apparatus 210 further includes a behavior prediction module (not illustrated), which is configured to determine the behavior prediction of one or more objects in the environment 100 based on the environment sensing result. The determined behavior prediction is provided to the vehicle-side control apparatus 220 via the communication module 212 for further assisting in controlling the driving behavior of the corresponding vehicle 110. The behavior prediction of the object includes one or more aspects of the expected motion trajectory, the expected motion speed, and the expected motion direction of the object. Since the autonomous driving control of the vehicle often needs to determine how the objects around the vehicle are about to move in order to take corresponding driving behaviors to respond, the behavior prediction of the object is also useful for the autonomous driving control of the vehicle.

In some embodiments, the behavior prediction module in the roadside assistance apparatus 210 may utilize a prediction model specific to the position or area where the sensor 105 is located to determine the behavior prediction of the object. Unlike the general prediction model for all objects or different types of objects used on the vehicle side, the prediction model local to the sensor 105 may be trained based on the behavior of the objects appearing in the area where the sensor 105 is located. The training data used to train the prediction model may be previously recorded behaviors of one or more objects in the area where the sensor 105 is located.

The objects appearing in different geographic areas may show specific behavioral patterns related to that area. For example, when the sensor 105 is arranged near a tourist attraction, the walking of people in this area may be less directional, and similar to wandering. When the sensor 105 is arranged near an office space such as an office building, the walking of people in this area may be more purposeful, for example, to one or more specific buildings. Therefore, by training the prediction model specific to the area, the behavior of the objects at the specific area may be predicted more accurately.

In some embodiments, the roadside assistance apparatus 210 further includes a driving recommendation module (not illustrated), the driving recommendation module is configured to determine the autonomous driving recommendation for one or more vehicles 110 based on the environment sensing result. The autonomous driving recommendation may include the driving path recommendation of the vehicle 110, the driving direction recommendation of the vehicle 110, or even include the specific operation instruction recommendation for controlling the driving behavior of the vehicle 110. The autonomous driving recommendation determined by the driving recommendation module is provided to the vehicle-side control apparatus 220 via the communication module 212 for further assisting in controlling the driving behavior of the corresponding vehicle 110.

In some embodiments, the driving recommendation module in the roadside assistance apparatus 210 may determine the autonomous driving recommendation by using the recommendation model specific to the area in which the sensor 105 is located. The recommendation model is trained based on the driving behavior performed by the vehicle in the area where the sensor 105 is located. The data configured to train the recommendation model may be previously recorded driving behaviors taken by one or more vehicles in the area where the sensor 105 is located. In different geographic areas, the vehicle may show the specific driving behavioral pattern related to that area. For example, at crowded intersections, the vehicle may perform the deceleration operation in advance. At some intersections, more vehicles may turn left. By training the recommendation model specific to the area, it can be more accurately provide the vehicle driving behavior suitable for execution at the specific area.

In some embodiments, the roadside assistance apparatus 210 may also provide other driving assistance information to the vehicle-side control apparatus 220, such as traffic conditions, accidents, and the like in the environment 100 monitored by the sensor 105. The information may help the vehicle-side control apparatus 220 to control the driving behavior of the vehicle 110 more accurately and reasonably.

According to some embodiments of the present disclosure, the roadside assistance apparatus 210 and the sensor 105 may jointly provide the vehicle-side control apparatus 220 with the environment sensing result, and may also provide the behavior prediction of the object and/or autonomous driving recommendation for assisting in controlling the driving behavior of the vehicle 110. The environment sensing result obtained by the roadside assistance apparatus 210 and the sensor 105 and other driving assistance information may be provided to multiple vehicles 110 in the environment 100, thereby achieving centralized environment sensing and information processing.

Under the implementation, the vehicle 110 may realize the autonomous driving without requiring it to have strong environmental perception ability, self-positioning capability, behavior prediction capability and/or autonomous driving planning capability. The improvement of the autonomous driving capability of the vehicle 110 may be achieved by integrating the vehicle-side control apparatus 220. For example, the function of the vehicle-side control apparatus 220 may be integrated into the vehicle 110 by upgrading the software system of the vehicle 110 and by an additional communication function, or by virtue of the communication function that the vehicle 110 has. In addition, the provision of the behavior prediction capability and/or autonomous driving recommendation by the roadside assistance apparatus 210 may guarantee the continuous autonomous driving process of the vehicle 110 in the event that the hardware and/or software of the vehicle 110 fails and the behavior prediction and driving planning cannot be performed.

The above described that the roadside assistance apparatus 210 realizes functions such as the environment sensing result, object behavior prediction, and/or autonomous driving control of the vehicle. In some embodiments, one, some or all of these functions may be performed by other devices with better computing capabilities, such as base stations or servers in the cloud, the edge computing site, or the roadside. The roadside assistance apparatus 210 may provide the sensing information of the sensor 105 to the corresponding processing device, obtain the processing result, and provide the processing result to the vehicle-side control apparatus 220.

Vehicle-Side Example Process

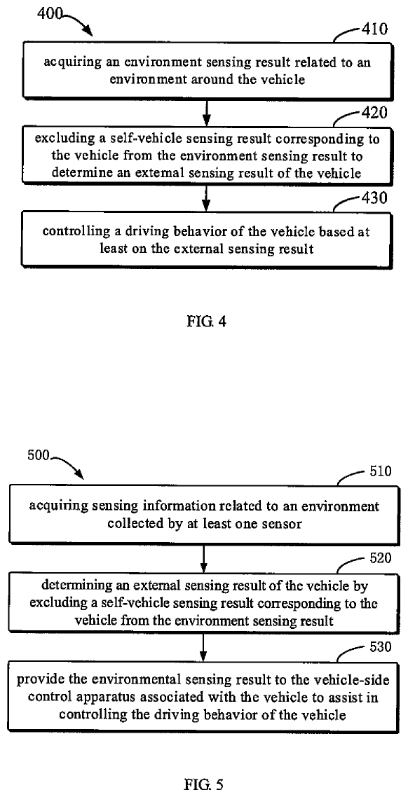

FIG. 4 is a flowchart of a method 400 for controlling autonomous driving of a vehicle according to some embodiments of the present disclosure. The method 400 may be implemented by the vehicle-side control apparatus 220 illustrated in FIG. 2. At block 410, the vehicle-side control apparatus 220 acquires an environment sensing result related to an environment around the vehicle. The environment sensing result is based on sensing information collected by at least one sensor arranged in the environment and independent of the vehicle, and the environment sensing result indicates relevant information of a plurality of objects in the environment. At block 402, the vehicle-side control apparatus 220 determines an external sensing result of the vehicle by excluding a self-vehicle sensing result corresponding to the vehicle from the environment sensing result. At block 430, the vehicle-side control apparatus 220 controls a driving behavior of the vehicle based at least on the external sensing result.

In some embodiments, controlling the driving behavior of the vehicle further includes: acquiring a behavior prediction of at least one object of multiple objects, and controlling the driving behavior of the vehicle based on the behavior prediction of the at least one object. The behavior prediction includes at least one of: an expected motion trajectory of the at least one object, an expected motion speed of the at least one object, and an expected motion direction of the at least one object.

In some embodiments, controlling the driving behavior of the vehicle further includes: acquiring an autonomous driving recommendation for the vehicle, and controlling the driving behavior of the vehicle based on the autonomous driving recommendation for the vehicle. The autonomous driving recommendation includes at least one of: a driving path recommendation of the vehicle, a driving direction recommendation of the vehicle, and an operation instruction recommendation for controlling the driving behavior of the vehicle.

In some embodiments, determining the external sensing result of the vehicle includes: identifying identification information related to a label section provided with the vehicle from the environment sensing result; determining the self-vehicle sensing result corresponding to the vehicle from the environment sensing result based on the identification information; and excluding the self-vehicle sensing result from the environment sensing result to obtain the external sensing result.

In some embodiments, the label section provided with the vehicle includes at least one of: a license plate of the vehicle, a two-dimensional code affixed to the outside of the vehicle, a non-visible light label affixed to the outside of the vehicle, and a radio frequency label mounted on the vehicle.

In some embodiments, the environment sensing result includes positions of multiple objects. Determining the external sensing result of the vehicle includes: determining a position of the vehicle; identifying an object matching the vehicle from the plurality of objects by matching the position of the vehicle with the positions of the plurality of objects; and excluding a sensing result corresponding to the object matching the vehicle from the environment sensing result to obtain the external sensing result.

In some embodiments, the method 400 further includes: determining a rough position of the vehicle in the environment; determining, from the environment sensing result, an object corresponding to the vehicle from multiple objects based on the rough position; and determining position information of the object corresponding to the vehicle included in the environment sensing result as a fine position of the vehicle in the environment.

In some embodiments, controlling the driving behavior of the vehicle further includes controlling the driving behavior of the vehicle based on the fine position of the vehicle.

In some embodiments, the at least one sensor includes at least one of: a sensor arranged near a road on which the vehicle is driving; and a sensor integrated on other vehicles in the environment.

Roadside Example Process

FIG. 5 is a flowchart of a method 500 for assisting in controlling autonomous driving of a vehicle according to some embodiments of the present disclosure. The method 500 may be implemented by the roadside control device 210 illustrated in FIG. 2. At block 510, the roadside control device 210 acquires sensing information related to an environment collected by at least one sensor. The at least one sensor is arranged in the environment and is independent of the vehicle. At block 520, the roadside control device 210 determines an environment sensing result related to the environment by processing the sensing information acquired. The environment sensing result indicates relevant information of multiple objects in the environment, and the multiple objects includes the vehicle. At block 530, the roadside control device 210 provides the environment sensing result to a vehicle-side control apparatus associated with the vehicle for assisting in controlling a driving behavior of the vehicle.

In some embodiments, the method 500 further includes determining a behavior prediction of at least one object of multiple objects based on the environment sensing result, and providing the behavior prediction determined to a vehicle-mounted control system for further assisting in controlling the driving behavior of the vehicle. The behavior prediction includes at least one of an expected motion trajectory, an expected motion speed, and an expected motion direction of the at least one object.

In some embodiments, determining the behavior prediction includes determining the behavior prediction by using a prediction model specific to an area where the at least one sensor is located. The prediction model is trained based on behaviors of another object appearing in the area.

In some embodiments, the method 500 further includes: determining an autonomous driving recommendation for the vehicle based on the environment sensing result, and providing the autonomous driving recommendation determined to the vehicle-mounted control system for further assisting in controlling the driving behavior of the vehicle. The autonomous driving recommendation includes at least one of a driving path recommendation of the vehicle, a driving direction recommendation of the vehicle, and an operation instruction recommendation for controlling the driving behavior of the vehicle.

In some embodiments, determining the autonomous driving recommendation includes determining the autonomous driving recommendation by using a recommendation model specific to an area in which the at least one sensor is located. The recommendation model is trained based on the driving behavior performed by another vehicle in the area.

In some embodiments, determining the environment sensing result includes: obtaining a static high definition map associated with the environment, and determining the environment sensing result based on the sensing information and the static high definition map. The static map at least indicates a position of a static object in the environment.

In some embodiments, determining the environment sensing result based on the sensing information and the static high definition map includes updating the static high definition map with the sensing information to obtain a real-time high definition map associated with the environment as the environment sensing result.

In some embodiments, the sensing information includes image sensing information. Determining the environment sensing result based on the sensing information and the static high definition map includes: identifying a static object and other objects in the environment from the image sensing information; and determining, based on a relative position relationship between the static object and other objects in the image sensing information, positions of other objects from a position of the static object indicated by the static high definition map.

In some embodiments, providing the external sensing result to the vehicle-side control apparatus includes: determining the external sensing result of the vehicle by excluding a self-vehicle sensing result corresponding to the vehicle from the environment sensing result; and sending the external sensing result to the vehicle-side control apparatus.

In some embodiments, determining the external sensing result of the vehicle includes: identifying identification information related to a label section provided with the vehicle from the environment sensing result; determining the self-vehicle sensing result corresponding to the vehicle from the environment sensing result based on the identification information; and excluding the self-vehicle sensing result from the environment sensing result to obtain the external sensing result.

In some embodiments, the label section provided with the vehicle includes at least one of: a license plate of the vehicle, a two-dimensional code affixed to the outside of the vehicle, a non-visible light label affixed to the outside of the vehicle, and a radio frequency label mounted on the vehicle.

In some embodiments, the at least one sensor includes at least one of: a sensor arranged near a road on which the vehicle is driving; and a sensor integrated on other vehicles in the environment.

Example Device Implementation

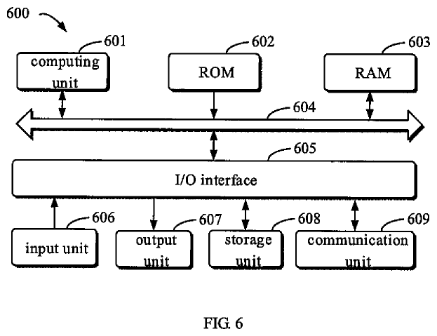

FIG. 6 shows a schematic block diagram of an example device 600 that may be used to implement embodiments of the present disclosure. The device 600 may be configured to implement the roadside assistance apparatus 210 or the vehicle-side device 220 illustrated in FIG. 2. As illustrated in the figure, the device 600 includes a computing unit 601, which may perform various suitable actions and processes in accordance with computer program instructions stored in a read only memory (ROM) 602 or loaded from a storage unit 608 into a random-access memory (RAM) 603. In the RAM 603, various programs and data necessary for operations of the device 600 may also be stored. The computing unit 601, the ROM 602, and the RAM 603 are connected to each other through a bus 604. An input/output (I/O) interface 605 is also connected to the bus 604.

A number of components in the device 600 are connected to the I/O interface 605, including: an input unit 606 such as a keyboard, a mouse, and the like; an output unit 607 such as various types of displays, speakers, etc.; the storage unit 608 such as a magnetic disk, an optical disk, or the like; and a communication unit 609 such as a network card, a modem, a wireless communication transceiver, and so on. The communication unit 609 allows the device 600 to exchange information/data with other devices via a computer network such as the Internet and/or various telecommunications networks.

The computing unit 601 may be various general-purpose and/or special-purpose processing components having processing and computing capabilities. Some examples of the computing unit 601 include, but are not limited to, a central processing unit (CPU), a graphics processing unit (GPU), various specialized artificial intelligence (AI) computing chips, various computing units running algorithms of machine learning models, digital signal processors (DSPs), any suitable processor, controllers, microcontrollers, and so on. The computing unit 601 may perform various methods and processes described above, such as the process 400 or the process 500. For example, in some embodiments, the processes 400 or 500′ may be implemented as a computer software program tangibly embodied on a machine-readable medium, such as the storage unit 608. In some embodiments, some or all of the computer programs may be loaded and/or installed onto the device 600 via the ROM 602 and/or the communication unit 609. When a computer program is loaded onto the RAM 603 and executed by the computing unit 601, one or more steps in processes 400 or 500 described above may be performed. Alternatively, in other embodiments, the computing unit 601 may be configured to perform the processes 400 or 500 in any other suitable manner (e.g., by way of the firmware).

The functions described herein above may be performed, at least in part, by one or more hardware logic components. For example, and without limitation, exemplary types of the hardware logic components that may be used include: a field programmable gate array (FPGA), an application specific integrated circuit (ASIC), an application specific standard product (ASSP), a system on chip (SOC), a complex programmable logic device (CPLD), and the like.

Program codes for performing the method in the present disclosure may be written in any combination of one or more programming languages. These program codes may be provided to a processor or controller in a general-purpose computer, a special purpose computer, or other programmable data processing devices, such that the program codes, when executed by the processor or controller, are configured to implement functions/operations specified in the flow chart and/or block diagrams. The program code may be executed entirely on a machine, partly on the machine, as a separate software package, partly on the machine, partly on a remote computer, or entirely on the remote computer or server.

In the context of the present disclosure, the machine-readable medium may be a tangible medium that may contain, or store a program for use by or in combination with an instruction execution system, an apparatus, or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium may include: an electrical connection having one or more wires, a portable computer disk, a hard disk, a random access memory (RAM), a read only memory (ROM), an Erasable Programmable Read Only Memory (EPROM or a flash memory), an optical fiber, a compact disc read-only memory (CD-ROM), an optical memory component, a magnetic memory component, or any suitable combination thereof.

Moreover, while operations are described in a particular order, this should be understood as that the operations are required to be performed in a particular illustrated order or in a sequential order, or that all illustrated operations are required to be performed to achieve desirable results. In certain circumstances, multitasking and parallel processing may be advantageous. Likewise, while several specific implementation details are included in the above discussion, these should not be construed as limiting the scope of the present disclosure. Certain features described in the context of separate embodiments may also be implemented in combination in a single implementation. Conversely, features that are described in the context of the single implementation may also be implemented in a plurality of implementations separately or in any suitable sub-combination.

Although the subject matter has been described in a language specific to structural features and/or methodological acts, it is to be understood that the subject matter defined in the attached claims is not necessarily limited to the specific features or acts described above. Instead, the specific features and acts described above are merely exemplary forms for implementing the attached claims.

1. A method for controlling autonomous driving of a vehicle, comprising:
acquiring an environment sensing result related to an environment around the vehicle, the environment sensing result being based on sensing information collected by at least one sensor arranged in the environment and independent of the vehicle, and the environment sensing result being configured to indicate relevant information of a plurality of objects in the environment;
determining an external sensing result of the vehicle by excluding a self-vehicle sensing result corresponding to the vehicle from the environment sensing result; and
controlling a driving behavior of the vehicle based at least on the external sensing result.

2. The method of claim 1, wherein controlling the driving behavior of the vehicle comprises:
acquiring a behavior prediction of at least one object of the plurality of objects, the behavior prediction comprising at least one of: an expected motion trajectory of the at least one object, an expected motion speed of the at least one object, and an expected motion direction of the at least one object; and
controlling the driving behavior of the vehicle based on the behavior prediction of the at least one object.

3. The method of claim 1, wherein controlling the driving behavior of the vehicle further comprises:
acquiring an autonomous driving recommendation, for the vehicle, the autonomous driving recommendation comprising at least one of: a driving path recommendation of the vehicle, a driving direction recommendation of the vehicle, and an operation instruction recommendation for controlling the driving behavior of the vehicle; and
controlling the driving behavior of the vehicle based on the autonomous driving recommendation for the vehicle.

4. The method of claim 1, wherein determining the external sensing result of the vehicle comprises:
identifying identification information related to a label section provided with the vehicle from the environment sensing result;
determining the self-vehicle sensing result corresponding to the vehicle from the environment sensing result based on the identification information; and
excluding the self-vehicle sensing result from the environment sensing result to obtain the external sensing result.

5. The method of claim 4, wherein the label section provided with the vehicle comprises at least one of: a license plate of the vehicle, a two-dimensional code affixed to an outside of the vehicle, a non-visible light label affixed to the outside of the vehicle, and a radio frequency label mounted on the vehicle.

6. The method of claim 1, wherein the environment sensing result comprises positions of the plurality of objects, and determining the external sensing result of the vehicle comprises:
determining a position of the vehicle;
identifying an object matching the vehicle from the plurality of objects by matching the position of the vehicle with the positions of the plurality of objects; and
excluding a sensing result corresponding to the object matching the vehicle from the environment sensing result to obtain the external sensing result.

7. The method of claim 1, further comprising:
determining a rough position of the vehicle in the environment;
determining, from the environment sensing result, an object corresponding to the vehicle from the plurality of objects based on the rough position; and
determining position information of the object corresponding to the vehicle comprised in the environment sensing result as a fine position of the vehicle in the environment.

8. The method of claim 7, wherein controlling the driving behavior of the vehicle further comprises:
controlling the driving behavior of the vehicle based on the fine position of the vehicle.

9. The method of claim 1, wherein the at least one sensor comprises at least one of:
a sensor arranged near a road on which the vehicle is driving; and
a sensor integrated on other vehicles in the environment.

10-19. (canceled)

20. A device, comprising:
one or more processors, and
a storage device, configured to store one or more programs,
wherein when the one or more programs are implemented by the one or more processors, the one or more processors are configured to:
acquire an environment sensing result related to an environment around the vehicle, the environment sensing result being based on sensing information collected by at least one sensor arranged in the environment and independent of the vehicle, and the environment sensing result being configured to indicate relevant information of a plurality of objects in the environment;
determine an external sensing result of the vehicle by excluding a self-vehicle sensing result corresponding to the vehicle from the environment sensing result; and
control a driving behavior of the vehicle based at least on the external sensing result.

21. (canceled)

22. A cooperative vehicles infrastructure system, comprising:
a vehicle-side control apparatus, comprising an apparatus for controlling autonomous driving of a vehicle;
at least one sensor disposed in an environment and independent of a vehicle, configured to collect sensing information related to the environment; and
a roadside assistance apparatus, configured to process the sensing information to determine an environment sensing result related to the environment,
wherein the apparatus for controlling autonomous driving of a vehicle comprises:
one or more processors, and
a storage device, configured to store one or more programs that, when implemented by the one or more processors, the one or more processors are configured to:
acquire an environment sensing result related to an environment around the vehicle, the environment sensing result being based on sensing information collected by at least one sensor arranged in the environment and independent of the vehicle, and the environment sensing result being configured to indicate relevant information of a plurality of objects in the environment;
determine an external sensing result of the vehicle y excluding a self-vehicle sensing result corresponding to the vehicle from the environment sensing result; and
control a driving behavior of the vehicle based at least on the external sensing result.

23. The device of claim 20, wherein the one or more processors are further configured to:
acquire a behavior prediction of at least one object of the plurality of objects, the behavior prediction comprising at least one of: an expected motion trajectory of the at least one object, an expected motion speed of the at least one object, and an expected motion direction of the at least one object; and
control the driving behavior of the vehicle based on the behavior prediction of the at least one object.

24. The device of claim 20, wherein the one or more processors are further configured to:
acquire an autonomous driving recommendation for the vehicle, the autonomous driving recommendation comprising at least one of: a driving path recommendation of the vehicle, a driving direction recommendation of the vehicle, and an operation instruction recommendation for controlling the driving behavior of the vehicle; and
control the driving behavior of the vehicle based on the autonomous driving recommendation for the vehicle.

25. The device of claim 20, wherein the one or more processors are further configured to:
identify identification information related to a label section provided with the vehicle from the environment sensing result;
determine the self-vehicle sensing result corresponding to the vehicle from the environment sensing result based on the identification information; and
exclude the self-vehicle sensing result from the environment sensing result to obtain the external sensing result.

26. The device of claim 25, wherein the label section provided with the vehicle comprises at least one of: a license plate of the vehicle, a two-dimensional code affixed to an outside of the vehicle, a non-visible light label affixed to the outside of the vehicle, and a radio frequency label mounted on the vehicle.

27. The device of claim 20, wherein the environment sensing result comprises positions of the plurality of objects, and the one or more processors are further configured to:
determine a position of the vehicle;
identify an object matching the vehicle from the plurality of objects by matching the position of the vehicle with the positions of the plurality of objects; and
exclude a sensing result corresponding to the object matching the vehicle from the environment sensing result to obtain the external sensing result.

28. The device of claim 20, wherein the one or more processors are further configured to:
determine a rough position of the vehicle in the environment;
determine, from the environment sensing result, an object corresponding to the vehicle from the plurality of objects based on the rough position; and
determine position information of the object corresponding to the vehicle comprised in the environment sensing result as a fine position of the vehicle in the environment.

29. The device of claim 28, wherein the one or more processors are further configured to:
control the driving behavior of the vehicle based on the fine position of the vehicle.

30. The device of claim 20, wherein the at least one sensor comprises at least one of:
a sensor arranged near a road on which the vehicle is driving; and
a sensor integrated on other vehicles in the environment.
